(19) United States
(12) Patent Application Publication
(10) Pub. No.: US 2001/0011056 A1
(43) Pub. Date: Aug. 2, 2001

(54) Method and apparatus for the centrifugal extraction of the liquid component of a compound product with recovery of energy from the said liquid component

(75) Inventor: Gennaro Pieralisi, (Ancona) (IT)

Correspondence Address: THE FIRM OF KARL F ROSS, 5676 RIVERDALE AVENUE, PO BOX 900, RIVERDALE (BRONX), NY, 10471-0900, US

(73) Assignee: NUOVA M.A.I.P. Macchine Agricol Industrial Pieralist S.P.A.

(21) Appl. No.: 09/768,856

(22) Filed: Jan. 24, 2001

(30) Foreign Application Priority Data
Feb. 2, 2000 (IT) MI2000A 156

(51) Int. Cl. B04B 1/20

(52) U.S. Cl. 494/53; 494/56

(57) ABSTRACT

Apparatus for the centrifugal separation and the extraction of at least one liquid component (1) and a solid component (2) from a compound product (P), comprising means (200,300,400) for recovery of part of the energy from the extracted liquid component (1).

### DESCRIPTION

The present invention relates to a method and an apparatus for the centrifugal separation and for the separate extraction of at least one liquid component from a compound product in substantially fluid form, which comprise means for the recovery of part of the inherent energy of the said liquid component leaving the apparatus.

In the art, extraction methods and associated machines called centrifugal extractors or decanters essentially comprising a feeder screw located inside a rotating drum and in turn rotating relative to the latter are known, which machines perform, inside the drum, separation and stratification of the various components of the product which may be composed of a solid part and at least one liquid part.

Said decanters are used, for example, in the dehydration of sludges produced by water treatment plants and the like.

In centrifugal separation machines of the known type the product to be separated normally consists of solid suspended in water which, during the centrifuging step, stratifies to a height radially closer to the axis of rotation than that of the solid residue which has a greater specific weight.

Once said separation has been obtained, recovery of the two components is performed by discharging said components via different outlet ducts from the centrifuge, respectively leading into the associated recovery channels.

In the abovementioned cases it has been found that the energy balance relating to the centrifugal separation operations is particularly negative since a high percentage of the energy supplied to the apparatus is lost via the residual energy contained in the products leaving the separator.

The technical problem which is posed therefore is that of providing a method and an apparatus for the centrifugal separation of products with several components, which are designed to allow a partial recovery of the energy supplied by the motor or motors to the fluid entering the decanter by means of centrifuging, in order to produce an improved overall efficiency of the process with a consequent reduction in the operating costs.

These technical problems are solved according to the present invention by a method and by an apparatus for the centrifugal separation and the extraction of at least one liquid component and a solid component from a compound product, which comprises means for recovery of part of the energy from the said extracted liquid component.

Further details may be obtained from the following description of a non-limiting example of embodiment of the invention, provided with reference to the accompanying drawings in which:

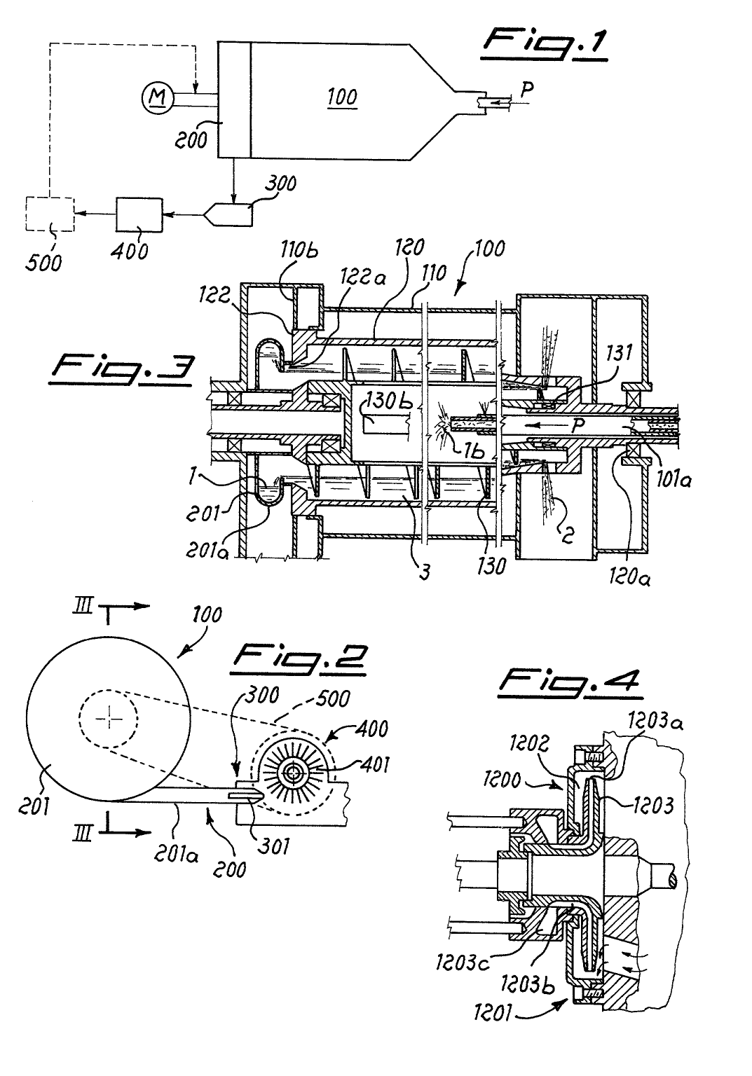

FIG. 1 shows a functional diagram of the apparatus according to the present invention;

FIG. 2 shows a front view of a first example of embodiment of the apparatus according to the present invention;

FIG. 3 shows a cross-section along the plane indicated by III-III in FIG. 2; and

FIG. 4 shows a cross-section, similar to that of FIG. 3, of a second example of embodiment of the apparatus according to the invention.

As shown in FIG. 1, the apparatus according to the invention comprises essentially:

a horizontal-axis centrifugal separator (referred to below as “decanter”) 100 which is actuated by a motor M and inputs all the energy necessary for centrifuging and which is provided with:

means 200 for collecting the liquid 1 leaving the decanter 100;

means 300 for conveying the liquid from the collecting means to the exterior;

means 400 for converting the energy of the liquid into utilisable mechanical energy;

means 500 for transmitting the mechanical energy to the motor M or directly to the rotor of the decanter 100.

In greater detail (see FIG. 3) a centrifugal extractor is composed essentially of a fixed casing 110 which is substantially cylindrical and provided, at its opposite ends, with annular sections which are separate from each other and open and which form radial headers 110a and 110b for recovery of the different components (also called phases) of the product to be separated, respectively formed by a solid residue 2 and by a liquid residue 3 consisting normally of water.

A rotating hollow drum 120 with a substantially cylindrical/frustoconical form is arranged inside the fixed casing 110 and coaxially therewith, said drum being mounted on bearings 120a so as to allow rotation thereof with respect to the casing 100; the power takeoff of the drum 120 is of the conventional type and therefore is not illustrated nor described in detail.

The front wall 122 of the drum 120 has holes 122a for discharging the liquid, which are arranged over a predefined diameter which determines the discharge level of the said liquid and therefore the filling level of the drum.

A feeder screw 130 is also arranged inside the drum 120 and coaxially therewith, being supported at the ends by bearings 131 integral with the drum 120 with respect to which the feeder screw is able to rotate. Said feeder screw 130 essentially consists of a hollow cylindrical/frustoconical body formed by circumferential segments 130a which are joined together so as to form longitudinal slits 130b for discharging the product 1b fed inside it in the direction of the arrow P by means of a pump (not shown) and a coaxial duct 101a.

The external surface of the feeder screw is constructed in the form of a helix which, rotating at a speed different from that of the drum, conveys the solid residue 2 towards the associated outlet 110a.

Said means 200 for collecting the liquid 1 extracted from the decanter are of the static type and consist of a header 201 in the form of a volute arranged coaxially with respect to the decanter and adjacent to the front closing wall 122 thereof so that the liquid emerging from the associated holes 122a flows into the static header 201 and is conveyed into a substantially horizontal duct 201a at the free end of which the means 300 for performing conveying to the exterior are arranged, said means consisting of a nozzle 301 for supplying the fluid to the processing means 400 consisting, for example, of a Pelton turbine 401 which is particularly suitable for the low flowrates which are typical of the process described.

Said nozzle may also be provided with means for regulating its outflow cross-section in order to adapt the speed of the Pelton turbine to the different flowrates of liquid leaving the decanter, said flowrates in turn depending on the dimensions and the operating conditions of the decanter 100.

A fluid provided with one part of energy in the form of kinetic energy and another part of energy in the form of a pressure energy must therefore reach the nozzle, it being the function of the nozzle to reconvert this pressure energy component into further kinetic energy. Although the conveying means have been described with reference to the presence of a discharge nozzle which allows regulation of the fluid jet onto the turbine, said means may also be formed by means of a simple free outflow channel without a nozzle; in this case the kinetic energy of the fluid would be directly available, but it would not be possible to regulate the fluid jet.

The action of the liquid jet on the blading causes rotation of the turbine 401, generating a driving torque and therefore a mechanical energy which, by suitable transmission means 500, may be supplied to the drum of the decanter, allowing the quantity of energy to be supplied by means of the motor M to be reduced. The description given above with reference to FIG. 3 relates to means 200 for conveying the liquid, of the direct type, although said conveying means could be of the indirect type 1200 as illustrated in FIG. 4.

In this case, the conveying means consist of a centripetal pump 1201 formed by an annular chamber 1202, which is integral with the drum of the decanter and rotates together therewith, and by a flow conveyor consisting of a static disk 1203 provided with internal ducts, i.e. a spiral duct 1203a arranged in a plane perpendicular to the axis of the decanter, a duct 1203b parallel to the axis and a collection duct 1203 which leads into a tangential outlet.

Since the part formed by the disk 1203 is fixed with respect to the rotating annular chamber 1202, the assembly forms a centripetal pump inside which a part of the kinetic energy of the liquid leaving the decanter is converted into pressure energy for correct operation of the nozzle and the turbine arranged downstream.

It is therefore obvious how the apparatus according to the invention allows recovery of the energy which would otherwise be lost since conveyed away by the system together with the liquid, therefore resulting in an increase in the overall efficiency of the said apparatus. This recovery moreover becomes even more useful for improving the energy balance of the centrifuge in those applications (sludge dehydration) where the liquid residue consists of a percentage equal to 80-98% of the product supplied to the separator. The objects of the present invention therefore also include a method for the centrifugal separation and the extraction of at least one liquid component 1 and a solid component 2 from a compound product P, which method also comprises at least one step for recovery of energy from the extracted liquid component.

In greater detail the method according to the invention comprises the following steps:

supplying of a compound product P to a centrifugal separator;

centrifugal separation of the solid component and the liquid component of the product P;

extraction of the liquid component from the centrifugal separator;

supplying of the extracted liquid component to means for recovery of the inherent energy of the said liquid component.

Within the context of the method described above a preferential embodiment may be regarded as where the separator is of the continuous type and collection of the liquid leaving the decanter is obtained by means of the direct type, such as static volutes, or by means of the indirect type, such as centripetal pumps and the like.

It is also pointed out how it is within the capacity of a person skilled in the art to make various modifications as regards realization of the component parts, without thereby departing from the protective scope of the patent defined by the claims which follow.

1. Apparatus for the centrifugal separation and the extraction of at least one liquid component (1) and a solid component (2) from a compound product (P), characterized in that it comprises means (200,300,400) for recovery of part of the energy from the extracted liquid component (1).

2. Apparatus according to claim 1, characterized in that it comprises a drum (120), provided with axial openings (122a) for discharging the liquid component (1), and a feeder screw (130) coaxially arranged inside it, both rotating independently of each other.

3. Apparatus according to claim 2, characterized in that said axial openings (122a) for discharging the liquid component (1) are formed over an adjustable-diameter circumference of the front face (122) of the drum (120).

4. Apparatus according to claim 1, characterized in that said energy recovery means comprise means (200) for collecting the liquid leaving the decanter, means (300) for conveying the liquid from the collecting means to the exterior, and means (400) for converting the energy of the liquid into utilisable mechanical energy.

5. Apparatus according to claim 4, characterized in that said means (200) for collecting the liquid are of the direct type.

6. Apparatus according to claim 5, characterized in that said means (200) for collecting the liquid leaving the decanter consist of a static header (201) substantially lying in a plane perpendicular to the axis of the decanter and with outflow of the liquid in a tangential direction.

7. Apparatus according to claim 4, characterized in that said means (1200) for collecting the liquid are of the indirect type.

8. Apparatus according to claim 7, characterized in that said collecting means consist of a centripetal pump.

9. Apparatus according to claim 8, characterized in that said centripetal pump is formed by an annular chamber (1202), which is integral with the drum of the decanter and rotates together therewith, and by a flow conveyor consisting of a static disk (1203) provided with internal ducts, i.e. a spiral duct (1203a) perpendicular to the axis of the decanter, a duct (1203b) parallel to the axis and a collecting duct (1203c) leading into a tangential outlet.

10. Apparatus according to claim 4, characterized in that said means (300) for conveying the liquid from the collecting means to the exterior are of the free outflow type.

11. Apparatus according to claim 4, characterized in that said means (300) for conveying the liquid from the collecting means to the exterior are of the controlled outflow type.

12. Apparatus according to claim 11, characterized in that it comprises a nozzle (301) associated with means for regulating the cross-section of its delivery aperture.

13. Apparatus according to claim 4, characterized in that said means (400) for converting the energy of the liquid into utilisable mechanical energy consist of a turbine.

14. Apparatus according to claim 2, characterized in that it comprises means (500) for transmission of the mechanical energy recovered to the drum of the decanter.

15. Apparatus according to claim 2, characterized in that it comprises means (500) for transmission of the mechanical energy recovered to an electric power generator.

16. Apparatus according to claim 1, characterized in that the centrifugal separator is a two-phase decanter.

17. Apparatus according to claim 1, characterized in that the centrifugal separator is a decanter comprising three or more phases.

18. Method for the centrifugal separation and the extraction of at least one liquid component (1) from a compound product (P), comprising the following steps:
supplying of a compound product P to a centrifugal separator;
centrifugal separation of the solid component and the liquid component of the product P;
extraction of the liquid component from the centrifugal separator;
supplying of the extracted liquid component to means for recovery of the inherent energy of the said liquid component.

19. Method according to claim 18, characterized in that the recovery of the liquid leaving the decanter is performed by means of the direct type.

20. Method according to claim 18, characterized in that recovery of the liquid leaving the decanter is performed by means of the indirect type.

21. Method according to claim 18, characterized in that the energy recovered is supplied to the centrifugal separator.

22. Method according to claim 18, characterized in that the centrifugal separator is of the continuous type.

23. Method according to claim 18, characterized in that the centrifugal separator is of the horizontal axis type.

24. Method according to claim 18, characterized in that the centrifugal separator is of the vertical axis type.
